(19) United States
(12) Patent Application Publication
(10) Pub. No.: US 2014/0289062 A1
(43) Pub. Date: Sep. 25, 2014

(54) Sales Support System for Proposing Product to Customer

(71) Applicant: KYOCERA Document Solutions Inc., Osaka (JP)

(72) Inventors: Chika TSUJI, Osaka (JP); Hiromi YAMAGAMI, Osaka (JP); Ryuichi ISHIZU, Osaka (JP); Yoshiyuki OSONO, Osaka (JP)

(73) Assignee: KYOCERA Document Solutions Inc., Osaka (JP)

(21) Appl. No.: 14/218,144

(22) Filed: Mar. 18, 2014

(30) Foreign Application Priority Data
Mar. 22, 2013 (JP) 2013-060701

(51) Int. Cl. G06Q 30/06

(52) U.S. Cl. CPC G06Q 30/0601
USPC 705/26.1

(57) ABSTRACT

A sales support system includes: a used equipment information receiving unit configured to receive used equipment information regarding a used equipment of a customer; a product proposal information generating unit configured to generate product proposal information that is used to propose a product to the customer; and a selected process receiving unit configured to receive a process for generating the product proposal information selected from a plurality of processes for generating the product proposal information by the product proposal information generating unit. The product proposal information generating unit is further configured to generate the product proposal information using the process received by the selected process receiving unit based on the used equipment information received by the used equipment information receiving unit.

### REFERENCE TO RELATED APPLICATIONS

This application is based upon and claims priority to the corresponding Japanese Patent Application No. 2013-060701, filed in the Japan Patent Office on Mar. 22, 2013, the entire contents of which are incorporated herein by reference.

### FIELD

The present disclosure relates to a sales support system configured to generate product proposal information that is used to propose a product to a customer.

### BACKGROUND

Atypical sales support system for proposing a product to a customer receives used equipment information regarding equipment used by a customer, and generates product proposal information based on the used equipment information.

In a typical sales support system, unless there is a change in the used equipment information, there is no change in the product proposal information that is generated based on the used equipment information. In other words, in a typical sales support system, process for generating the product proposal information based on the used equipment information is fixed. Therefore, in a typical sales support system, even if the generated product proposal information is suitable for a certain customer, the information may be unsuitable for other customers. Further, in a typical sales support system, even if the generated product proposal information is suitable for a customer at a certain point in time, the information may be unsuitable for the customer at other points in time.

### SUMMARY

A sales support system according to an embodiment of the present disclosure includes a used equipment information receiving unit, a product proposal information generating unit, and a selected process receiving unit. The used equipment information receiving unit is configured to receive used equipment information regarding a used equipment of a customer. The product proposal information generating unit is configured to generate product proposal information that is used to propose a product to the customer. The selected process receiving unit is configured to receive a process for generating the product proposal information selected from a plurality of processes for generating the product proposal information by the product proposal information generating unit. The product proposal information generating unit is further configured to generate the product proposal information using the process received by the selected process receiving unit based on the used equipment information received by the used equipment information receiving unit.

A sales support method according to an embodiment of the present disclosure includes: (i) receiving, via a used equipment information receiving unit, used equipment information about a used equipment of a customer; (ii) generating, via a product proposal information generating unit, product proposal information that is used to propose a product to the customer; (iii) receiving, via a selected process receiving unit, a process for generating the product proposal information selected from a plurality of processes for generating the product proposal information by the product proposal information generating unit; and (iv) generating, by the product proposal information generating unit, the product proposal information using the process received by the selected process receiving unit based on the used equipment information received by the used equipment information receiving unit.

A non-transitory computer-readable recording medium according to an embodiment of the present disclosure stores a sales support program executable by a computer. The sales support program includes: a first program code for causing the computer to receive used equipment information regarding a used equipment of a customer; a second program code for causing the computer to generate product proposal information that is used to propose a product to the customer; and a third program code for causing the computer to receive a process for generating the product proposal information selected from a plurality of processes for generating the product proposal information by the second program code. The second program code further causes the computer to generate the product proposal information using the process received by the third program code based on the used equipment information received by the first program code.

Additional features and advantages are described herein, and will be apparent from the following detailed description and the figures.

### BRIEF DESCRIPTION OF THE DRAWINGS

All drawings are intended to illustrate some aspects and examples of the present disclosure. The drawings described are only schematic and are non-limiting, and are not necessarily drawn to scale.

FIG. 1 shows a configuration of a sales support system according to an embodiment of the present disclosure.

FIG. 2 shows a configuration of a user terminal as shown in FIG. 1.

FIG. 3 shows a configuration of a sales support server as shown in FIG. 1.

FIG. 4 shows exemplary catalog information as shown in FIG. 3.

FIG. 5 shows an exemplary first print speed range table for an A3 color MFP as shown in FIG. 3.

FIG. 6 shows a configuration of an image forming system for a customer of a dealer as a user of a user terminal.

FIG. 7 shows exemplary used equipment information collected by a used equipment information collecting device as shown in FIG. 6.

FIG. 8 shows a procedure of operations of the sales support system when product proposal information is generated.

FIG. 9 shows an exemplary equipment list screen displayed on a display unit of the user terminal.

FIG. 10 shows another exemplary equipment list screen displayed on the display unit of the user terminal.

FIG. 11 shows an exemplary candidate list screen displayed on the display unit of the user terminal.

FIG. 12 shows an exemplary equipment list screen displayed on the display unit of the user terminal.

FIG. 13 shows a procedure of operations of the sales support server as shown in FIG. 3 when the product proposal information is generated.

FIG. 14 shows a process of Hybrid suggestion processing as shown in FIG. 13.

FIG. 15 shows a process of Based on monthly volume processing as shown in FIG. 13.

FIG. 16 shows a process of Based on current device processing as shown in FIG. 13.

### DETAILED DESCRIPTION

Various embodiments are described below with reference to the figures. It should be understood, however, that numerous variations from the depicted arrangements and functions are possible while remaining within the scope and spirit of the claims. For instance, one or more elements may be added, removed, combined, distributed, substituted, re-positioned, re-ordered, and/or otherwise changed. Further, where this description refers to one or more functions being implemented on and/or by one or more devices, one or more machines, and/or one or more networks, it should be understood that one or more of such entities could carry out one or more of such functions by themselves or in cooperation, and may do so by application of any suitable combination of hardware, firmware, and/or software. For instance, one or more processors may execute one or more sets of programming instructions as at least part of carrying out one or more of the functions described herein.

An embodiment of the present disclosure is described in the following with reference to the attached drawings.

First, a configuration of a sales support system according to the embodiment is described.

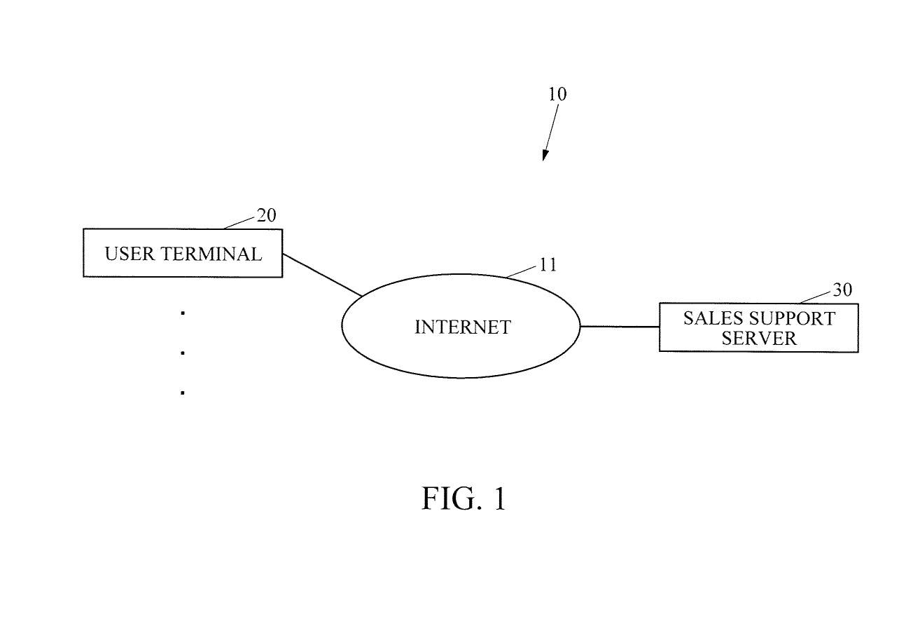

FIG. 1 shows a configuration of the sales support system 10 according to the embodiment.

As depicted in FIG. 1, a sales support system 10 includes a plurality of user terminals including a user terminal 20 used by a dealer of a product such as an image forming apparatus, and a sales support server 30 configured to generate product proposal information that is used to propose a product to a customer of the dealer, where the dealer is the user of the user terminal.

The plurality of user terminals and the sales support server 30 in the sales support system 10 are connected so as to allow communication with each other via the Internet 11 or another network.

The configuration of each of the plurality of user terminals in the sales support system 10 are each similar to a configuration of the user terminal 20. Therefore, in the following, the user terminal 20 is described and is a representative of the plurality of user terminals in the sales support system 10.

Note that, the sales support server 30 is managed by a manufacturer of the product. Further, users of the user terminals are dealers of the product. The dealers may sell the product of the manufacturer that manages the sales support server 30 as well as a product of another manufacturer.

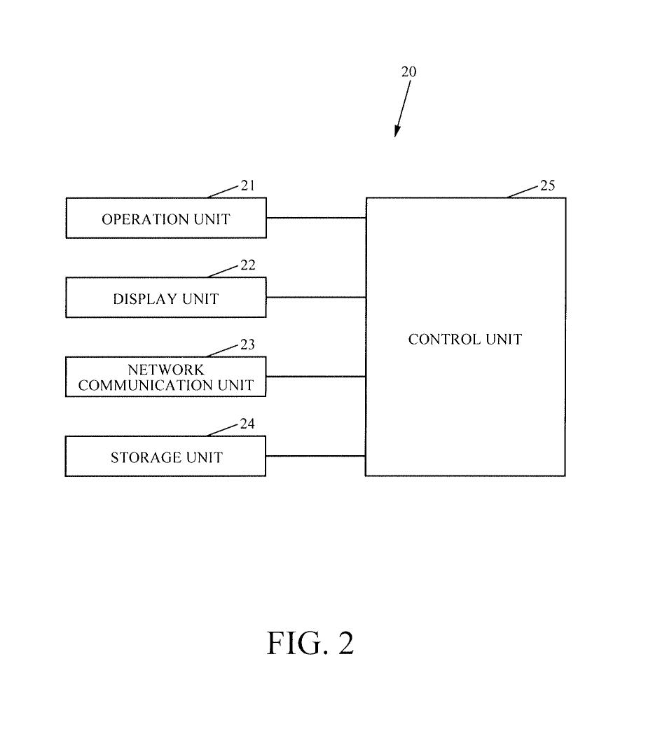

FIG. 2 shows a configuration of the user terminal 20.

As depicted in FIG. 2, the user terminal 20 includes an operation unit 21, a display unit 22, a network communication unit 23, a storage unit 24, and a control unit 25. The operation unit 21 may be an input device such as a mouse or a keyboard through that various operations are input. The display unit 22 may be a liquid crystal display (LCD) configured to display various kinds of information. The network communication unit 23 is configured to communicate to/from an external device via the Internet 11 as shown in FIG. 1 or another network. The storage unit 24 may be a hard disk drive (HDD) configured to store programs and different kinds of data. The control unit 25 is configured to control the entire user terminal 20. The user terminal 20 may be a part of a computer such as a personal computer (PC) and a tablet terminal.

The control unit 25 is provided with, for example, a central processing unit (CPU), a read only memory (ROM) configured to store programs and different kinds of data, and a random access memory (RAM) used as a work area for the CPU. The CPU is configured to execute the programs stored in the ROM or the storage unit 24.

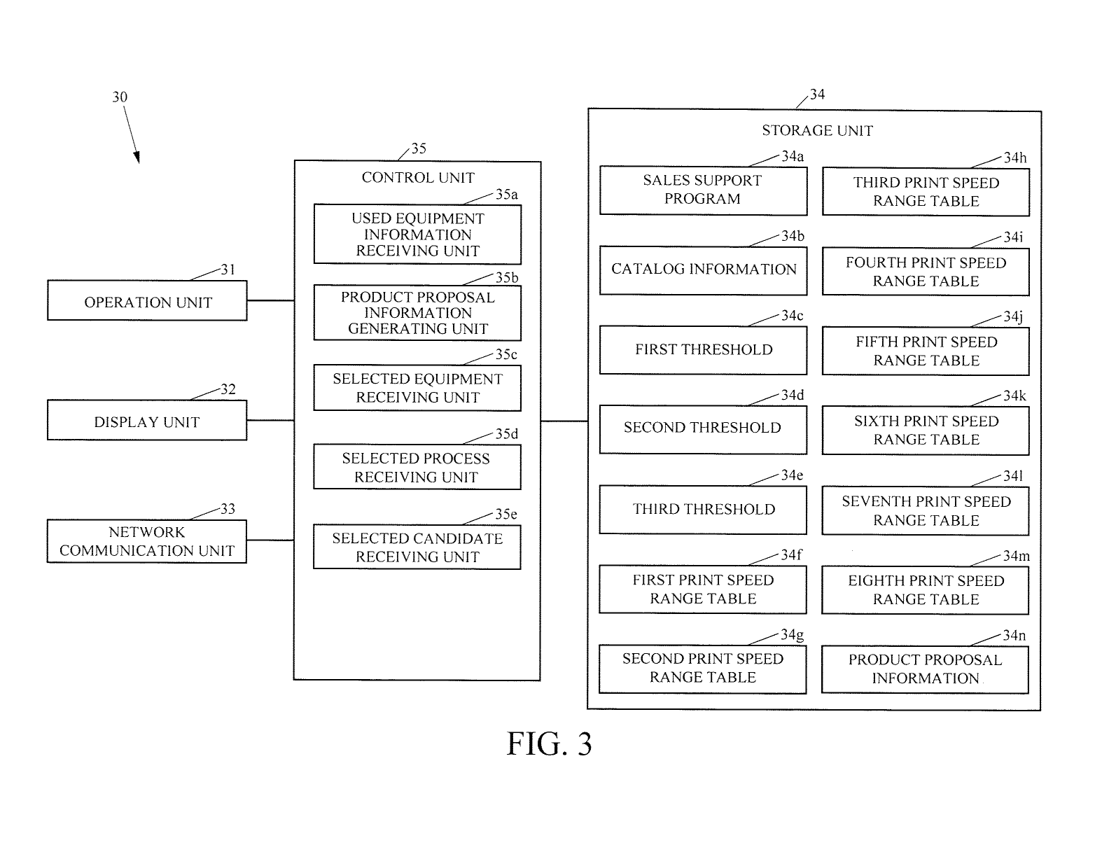

FIG. 3 shows a configuration of the sales support server 30.

As depicted in FIG. 3, the sales support server 30 includes an operation unit 31, a display unit 32, a network communication unit 33, a storage unit 34, and a control unit 35. The operation unit 31 may be an input device such as a mouse or a keyboard through that various operations are input. The display unit 32 may be an LCD configured to display various kinds of information. The network communication unit 33 configured to communicate to/from an external device via the Internet 11 as shown in FIG. 1 or another network. The storage unit 34 may be an HDD configured to store programs and different kinds of data. The control unit 35 is configured to control the entire sales support server 30. The sales support server 30 may be a part of a computer such as a PC.

The storage unit 34 stores a sales support program 34a for supporting sales by the dealer, where the dealer is the user of the user terminal. The sales support program 34a may be installed into the sales support server 30 at a stage of manufacturing the sales support server 30, may be additionally installed into the sales support server 30 from a storage medium such as a compact disc (CD) or a digital versatile disc (DVD), or may be additionally installed into the sales support server 30 from the Internet 11 or another network.

Further, the storage unit 34 can store catalog information 34b that includes information regarding image forming apparatus as the products. Note that, products included in the catalog information 34b may include products of the manufacturer that manages the sales support server 30 and a product of another manufacturer.

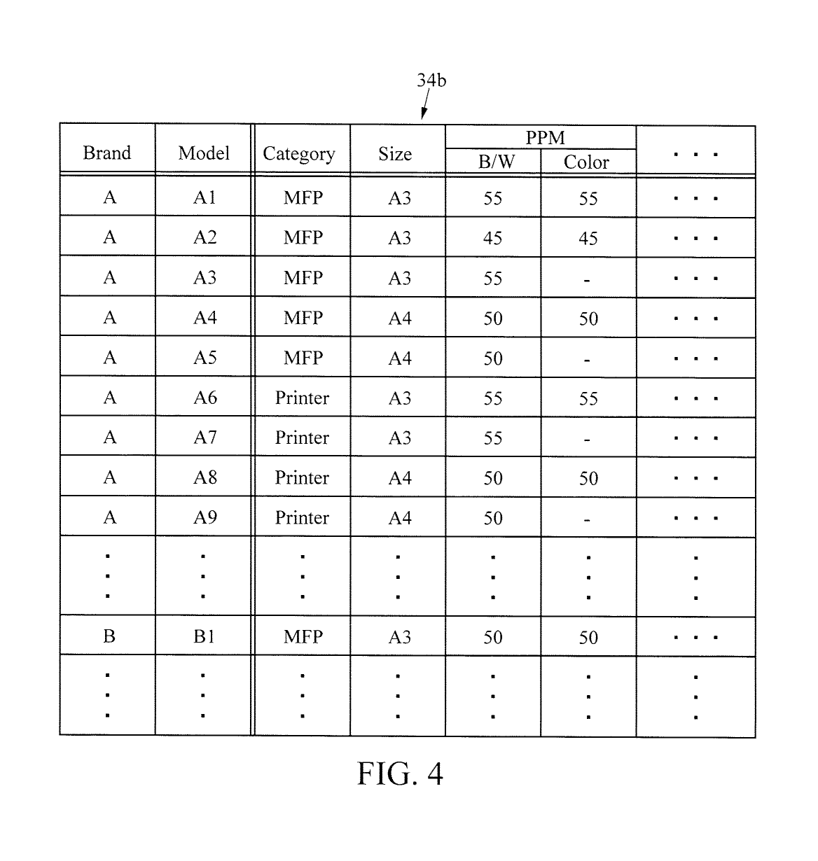

FIG. 4 shows exemplary catalog information 34b.

As shown in FIG. 4, the catalog information 34b includes, for example, “Brand” as an item indicating the manufacturer of the product, “Model” as an item indicating the name of the product, “Category” as an item indicating the type of product based on the kind of the job executable by the product, “Size” as an item indicating the maximum paper size printable by the product, and “PPM” as an item indicating the print speed of the product.

The catalog information 34b may include information regarding products of a plurality of manufacturers. Specifically, the catalog information 34b may include a plurality of different values under “Brand”, where each value represents a manufacturer.

The catalog information 34b includes information regarding a plurality of products. Specifically, the catalog information 34b may include a variety of “Brand” and “Model” values in combination corresponding to different brands and models.

For a given product, the “Category” as shown in FIG. 4 may be an “MFP” indicating a multifunction peripheral (MFP) or a “Printer” indicating a dedicated printer. An MFP can execute a “Print” job, a “Copy” job, a “FAX” job, and a “Scan” job, for example. A “Print” job produces a print based on print data transmitted from an external device. A “Copy” job produces a print of an image scanned by a scanner. A “FAX” job transmits or receives a facsimile to or from an external facsimile machine. A “Scan” job generates image data from an image scanned by a scanner. A dedicated printer can execute the “Print” job, but cannot execute any of the “Copy” job, the “FAX” job, and the “Scan” job.

Regarding the item “Size” in the catalog information 34b, “A3” and “A4” are shown in FIG. 4. “A3” indicates that the maximum paper size printable by the product is A3 size. “A4” indicates that the maximum paper size printable by the product is A4 size. Specifically, a product whose value of the item “Size” is “A3” is a so-called A3 machine, and a product whose value of the item “Size” is “A4” is a so-called A4 machine.

The item “PPM” (meaning pages per minute) in the catalog information 34b is further broken down into “B/W” indicating the monochrome print speed of the product and “Color” indicating the color print speed of the product. The value of the item “B/W” indicates the number of sheets that can be printed per minute using only black ink or toner. The value of the item “Color” indicates the number of sheets that can be printed per minute using all colors of ink or toner. Note that, when the value of the item “Color” is “−”, the product does not execute color printing. Specifically, a product whose value of the item “Color” is “−” is a so-called monochrome machine, and a product whose value of the item “Color” is other than “−” is a so-called color machine.

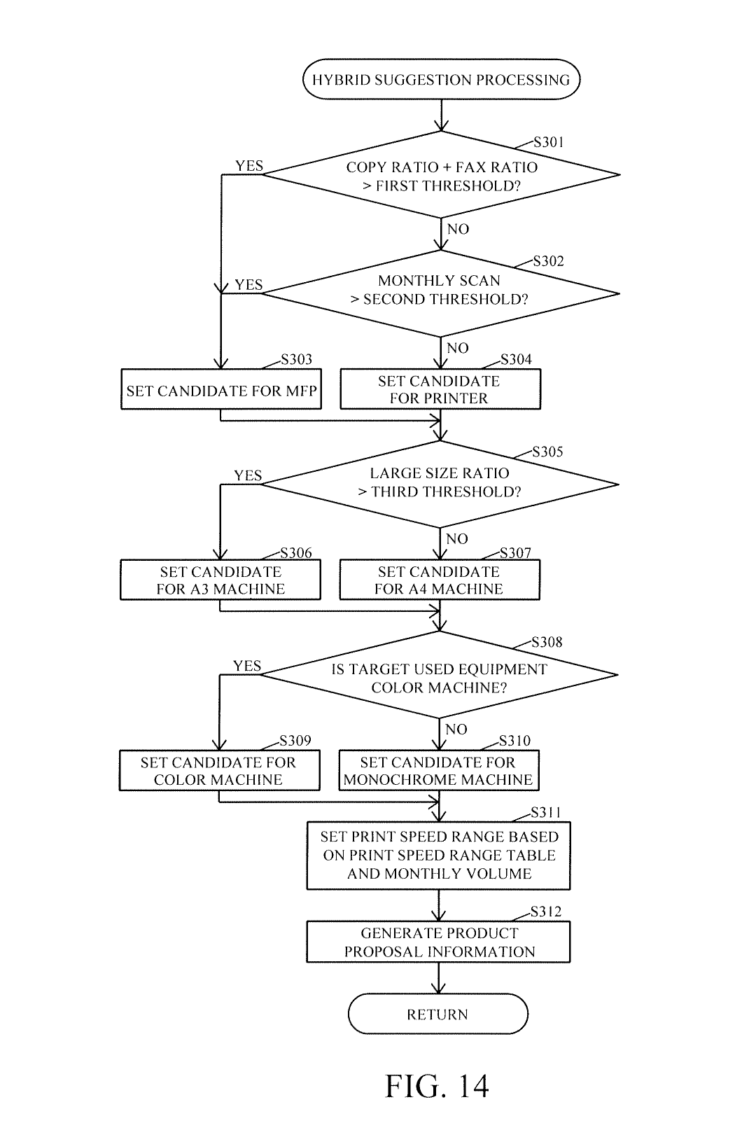

As depicted in FIG. 3, the storage unit 34 can store a first threshold 34c, a second threshold 34d, and a third threshold 34e (collectively, the thresholds may be referred to herein as “suggestion thresholds”). The suggestion thresholds are used in a hybrid suggestion processing procedure (described later and depicted in FIG. 14) to help select a certain product to be used in a generated product proposal. The first threshold 34c and the second threshold 34d are used to determine whether the product to be selected is an MFP or a printer, and the third threshold 34e is used to determine whether the product to be selected is an A3 machine or an A4 machine. Note that other factors are considered during the hybrid suggestion processing procedure in combination with the suggestion thresholds, which are described later and depicted in FIG. 14. Also note that the suggestion thresholds may each be set from the user terminal 20 via the Internet 11 or another network, for example.

Further, the storage unit 34 can store print speed range tables for determining the range of the print speed of the product as a candidate to be proposed. There are eight kinds of print speed range tables which the storage unit 34 can store: a first print speed range table 34f for an A3 color MFP; a second print speed range table 34g for an A3 monochrome MFP; a third print speed range table 34h for an A4 color MFP; a fourth print speed range table 34i for an A4 monochrome MFP; a fifth print speed range table 34j for an A3 color printer; a sixth print speed range table 34k for an A3 monochrome printer; a seventh print speed range table 341 for an A4 color printer; and an eighth print speed range table 34m for an A4 monochrome printer.

The first print speed range table 34f for an A3 color MFP corresponds to a product whose value of the item “Category” is “MFP”, whose value of the item “Size” is “A3”, and whose value of the item “Color” in the item. “PPM” is other than “−” in the catalog information 34b. The second print speed range table 34g for an A3 monochrome MFP corresponds to a product whose value of the item “Category” is “MFP”, whose value of the item “Size” is “A3”, and whose value of the item “Color” in the item “PPM” is “−” in the catalog information 34b. The third print speed range table 34h for an A4 color MFP corresponds to a product whose value of the item “Category” is “MFP”, whose value of the item “Size” is “A4”, and whose value of the item “Color” in the item “PPM” is other than “−” in the catalog information 34b. The fourth print speed range table 34i for an A4 monochrome MFP corresponds to a product whose value of the item “Category” is “MFP”, whose value of the item “Size” is “A4”, and whose value of the item “Color” in the item “PPM” is “−” in the catalog information 34b. The fifth print speed range table 34j for an A3 color printer corresponds to a product whose value of the item “Category” is “Printer”, whose value of the item “Size” is “A3”, and whose value of the item “Color” in the item “PPM” is other than “−” in the catalog information 34b. The sixth print speed range table 34k for an A3 monochrome printer corresponds to a product whose value of the item “Category” is “Printer”, whose value of the item “Size” is “A3”, and whose value of the item “Color” in the item “PPM” is “−” in the catalog information 34b. The seventh print speed range table 341 for an A4 color printer corresponds to a product whose value of the item “Category” is “Printer”, whose value of the item “Size” is “A4”, and whose value of the item “Color” in the item “PPM” is other than “−” in the catalog information 34b. The eighth print speed range table 34m for an A4 monochrome printer corresponds to a product whose value of the item “Category” is “Printer”, whose value of the item “Size” is “A4”, and whose value of the item “Color” in the item “PPM” is “−” in the catalog information 34b.

In the following, the first print speed range table 34f for an A3 color MFP as a representative of the eight kinds of print speed range tables the storage unit 34 can store is described in detail. Note that, the first print speed range table 34f for an A3 color MFP and the tables other than the first print speed range table 34f for an A3 color MFP of the eight kinds of print speed range tables the storage unit 34 can store are different in the respective values in the tables, but are similar in configuration.

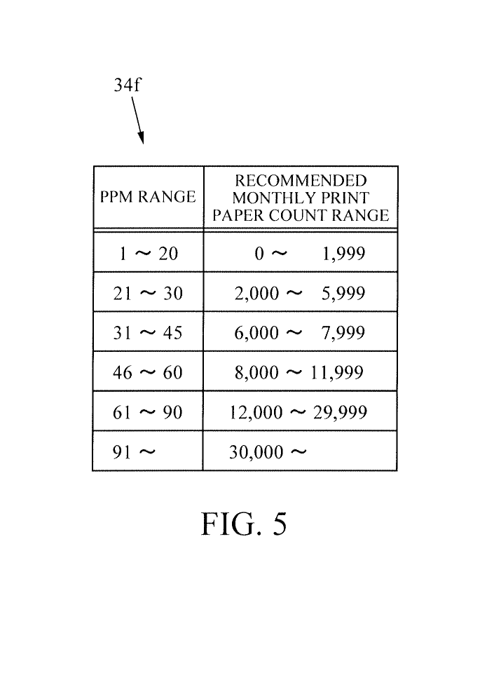

FIG. 5 shows an exemplary first print speed range table 34f for an A3 color MFP as shown in FIG. 3.

As shown in FIG. 5, the first print speed range table 34f for an A3 color MFP includes “PPM Range” indicating the print speed range (in pages per minute) of the product and “Recommended Monthly Print Paper Count Range” indicating the recommended monthly print paper count range of the product. For example, in FIG. 5, “1-20” as a value of the item “PPM Range” corresponds to “0-1, 999” as a value of the item “Recommended Monthly Print Paper Count Range”.

As shown in FIG. 3, the storage unit 34 can store product proposal information 34n that is used to propose a product to a customer of the dealer, where the dealer is the user of the user terminal.

The control unit 35 includes, for example, a CPU, a ROM configured to store programs and various kinds of data, and a RAM used as a work area for the CPU. The CPU runs a program stored in the ROM or the storage unit 34.

By running the sales support program 34a stored in the storage unit 34, the control unit 35 functions as a used equipment information receiving unit 35a for receiving used equipment information regarding image forming apparatus as equipment used by the customer, a product proposal information generating unit 35b for generating the product proposal information 34n, a selected equipment receiving unit 35c for receiving used equipment that is selected from used equipment included in the used equipment information, a selected process receiving unit 35d for receiving a process for generating the product proposal information selected from a plurality of processes for generating the product proposal information 34n by the product proposal information generating unit 35b, and a selected candidate receiving unit 35e for receiving a candidate selected from product candidates included in the product proposal information 34n.

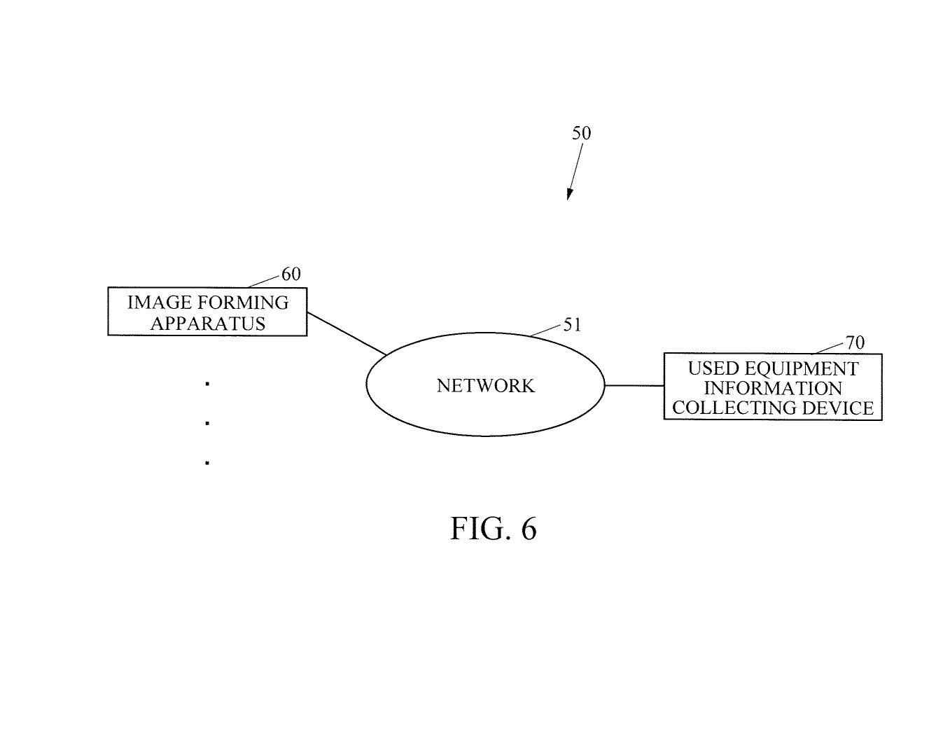

FIG. 6 shows a configuration of an image forming system 50 for a customer of the dealer as the user of the user terminal 20.

As shown in FIG. 6, the image forming system 50 includes a plurality of image forming apparatuses including an image forming apparatus 60, and a used equipment information collecting device 70. The used equipment information collecting device 70 is a computer configured to automatically collect and transmit the used equipment information, which includes information of the plurality of image forming apparatus included in the image forming system 50. The used equipment information collecting device 70 may be included in the sales support system of the embodiment. The image forming system 50 includes an image forming apparatus, for example, an MFP and a dedicated printer.

The plurality of image forming apparatuses and the used equipment information collecting device 70 in the image forming system 50 are connected to allow communication with each other via a network 51 such as a local area network (LAN), the Internet, or the like.

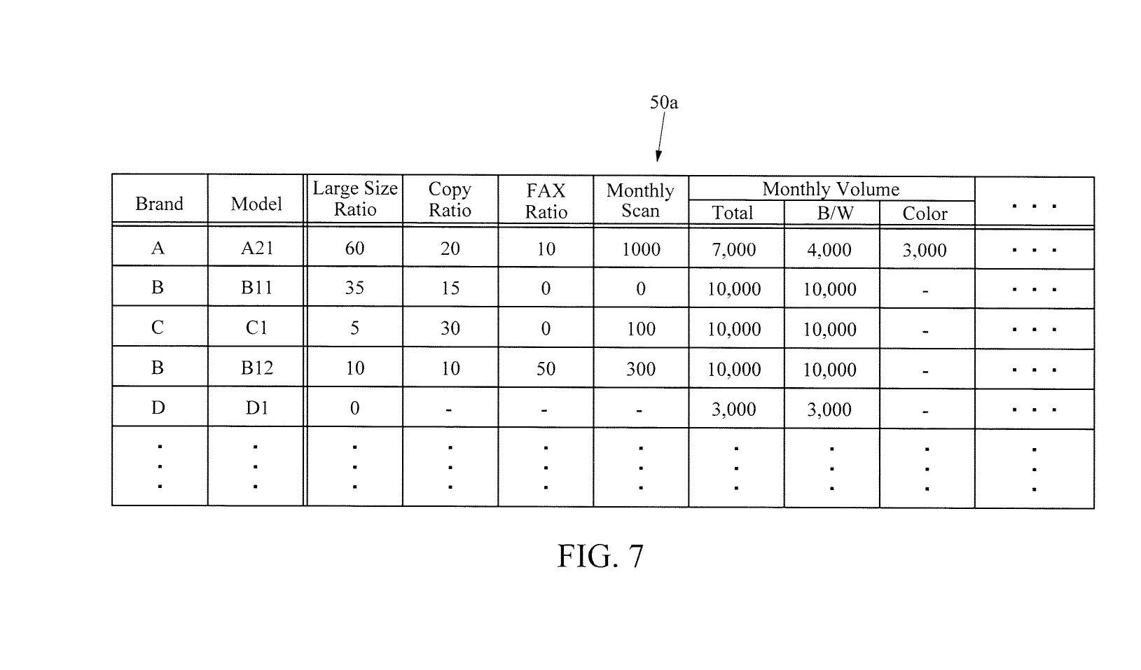

FIG. 7 shows exemplary used equipment information 50a collected by the used equipment information collecting device 70.

As shown in FIG. 7, the used equipment information 50a includes, for example, “Brand” as an item indicating the manufacturer of the used equipment and “Model” as an item indicating the name of the used equipment.

Further, the used equipment information 50a includes, for example, “Large Size Ratio” as an item indicating the ratio of the print paper count regarding paper sizes larger than the A4 size to the actual total print paper count by the used equipment, “Copy Ratio” as an item indicating the ratio of the actual print paper count in the “Copy” job to the actual total print paper count by the used equipment, and “FAX Ratio” as an item indicating the ratio of the actual print paper count in the “FAX” job to the actual total print paper count by the used equipment.

Further, the used equipment information 50 includes, for example, “Monthly Scan” as an item indicating the actual monthly scan paper count in the “Scan” job by the used equipment and “Monthly Volume” as an item indicating the actual monthly print paper count by the used equipment.

The item “Brand” and the item “Model” in the used equipment information 50a are similar to the item “Brand” and the item “Model”, respectively, in the catalog information 34b (see FIG. 4), and thus, description thereof is omitted.

The item “Monthly Volume” in the used equipment information 50a includes “B/W” as an item indicating the actual monthly monochrome print paper count by the used equipment, “Color” as an item indicating the actual monthly color print paper count by the used equipment, and “Total” as an item indicating the total value of the value of the item “B/W” and the value of the item “Color”. Note that, the values in the item “Monthly Volume” are calculated by, for example, dividing the actual total print paper count by the used equipment by the number of months during that the used equipment is used.

Next, operation of the sales support system 10 is described.

First, a flow when the product proposal information is generated is described.

The dealer being the user of the user terminal 20 obtains the used equipment information 50a that is output by the used equipment information collecting device 70 in the image forming system 50. The used equipment information collecting device 70 can export the collected used equipment information 50a as a comma separated values (CSV) file based on instructions from the dealer, for example. The dealer may directly obtain the used equipment information 50a that is exported as a CSV file from the image forming apparatus in the image forming system 50, not via the used equipment information collecting device 70.

Note that, the used equipment information 50a obtained by the dealer from the image forming system 50 is information indicating the print environment of the customer.

The dealer can instruct the user terminal 20 to log in to the sales support server 30 by, for example, inputting a user ID and password of the dealer via the operation unit 21 of the user terminal 20. The control unit 25 of the user terminal 20 requests, under instructions from the dealer, a login to the sales support server 30 from the sales support server 30 via the network communication unit 23.

If the combination of the user ID and password of the dealer that is input via the network communication unit 33 is stored in the storage unit 34, the control unit 35 of the sales support server 30 determines that authentication of the dealer is successful, and permits the login of the dealer.

After the login to the sales support server 30, the dealer can instruct the sales support server 30 to generate the product proposal information via the user terminal 20 by instructing, via the operation unit 21, the user terminal 20 to import to the sales support server 30 the used equipment information 50a obtained as a CSV file from the image forming system 50.

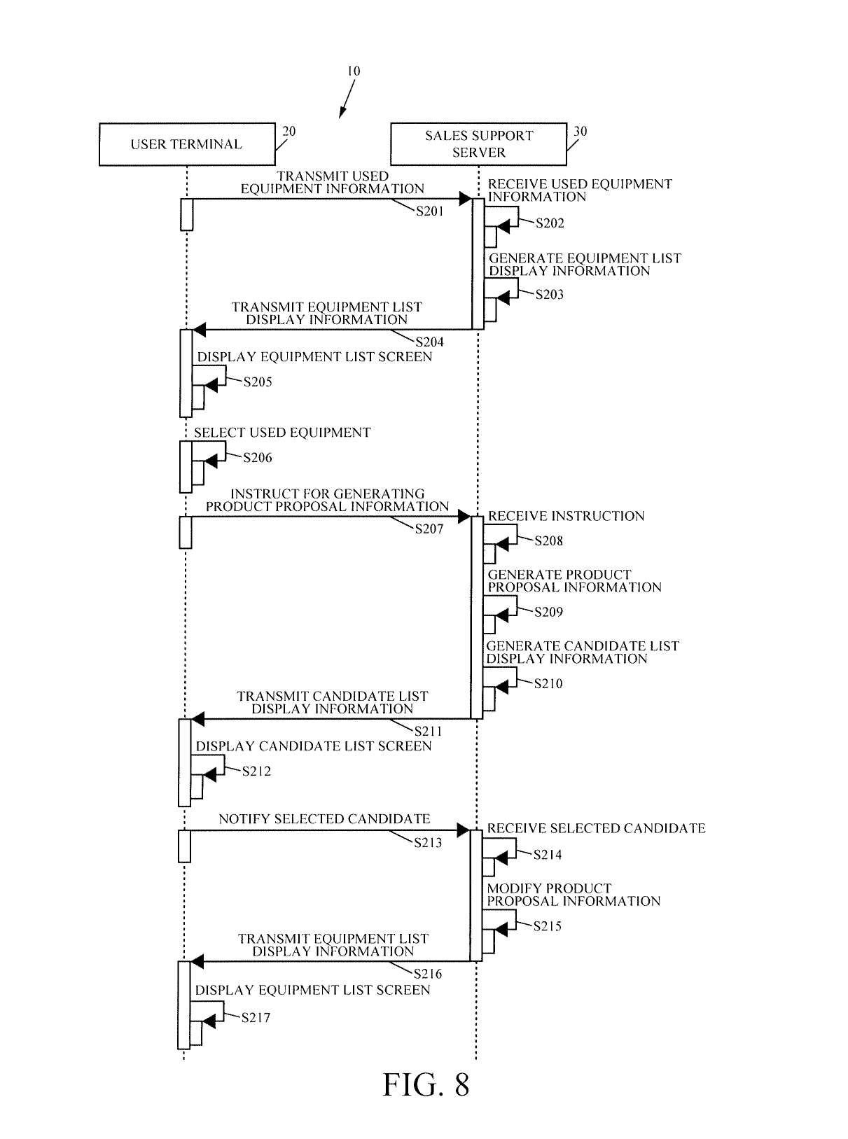

FIG. 8 shows a procedure of operations of the sales support system 10 when the product proposal information is generated.

As shown in FIG. 8, the control unit 25 of the user terminal 20 transmits, under instructions from the dealer, the used equipment information 50a via the network communication unit 23 to the sales support server 30 (S201).

Then, the used equipment information receiving unit 35a of the control unit 35 of the sales support server 30 receives via the network communication unit 33 the used equipment information 50a transmitted from the user terminal 20 in S201 (S202).

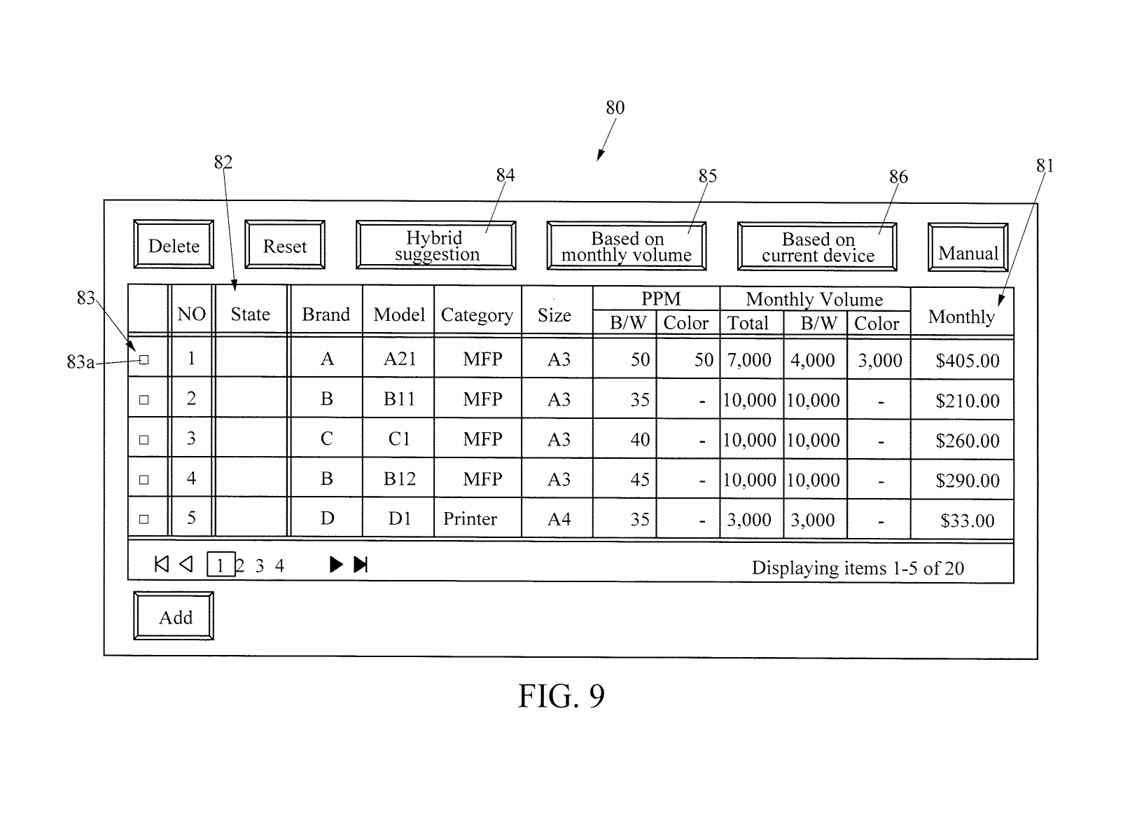

Then, the product proposal information generating unit 35b of the control unit 35 generates, based on the used equipment information 50a received in S202 and the catalog information 34b on the storage unit 34, information for displaying an equipment list screen 80 that, as shown in FIG. 9, displays a list of image forming apparatus included in the used equipment information 50a that is received in S202 (hereinafter referred to as “equipment list display information”) (S203).

FIG. 9 shows an exemplary equipment list screen 80 displayed on the display unit 22 of the user terminal 20.

As shown in FIG. 9, the equipment list screen 80 includes an equipment display region 81 for displaying a list of image forming apparatus, a state display region 82 for displaying the states of the image forming apparatus displayed in the equipment display region 81, a selection state display region 83 for displaying selection states of the image forming apparatus displayed in the equipment display region 81, and a button 84, a button 85, and a button 86 for instructing generation of the product proposal information.

The equipment display region 81 includes as items, for example, “Brand”, “Model”, “Category”, “Size”, “PPM”, and “Monthly Volume”, and “Monthly” as an item indicating the actual monthly billed amount of the image forming apparatus.

The state display region 82 includes “State” as an item indicating the state of the image forming apparatus.

The selection state display region 83 includes check boxes 83a each indicating a selection state of the image forming apparatus.

The button 84 is used for providing an instruction to generate the product proposal information by using the process “Hybrid suggestion” as the process of generating product proposal information 34n that places prime importance on the actual usage of the used equipment.

The button 85 is used for providing an instruction to generate the product proposal information by using the process “Based on monthly volume” as the process of generating product proposal information 34n that places importance on a specification value of the used equipment and considers only “Monthly Volume” as the actual usage of the used equipment.

The button 86 is used for providing an instruction to generate the product proposal information by using the process “Based on current device” as the process of generating product proposal information 34n that places prime importance on the specification value of the used equipment.

As shown in FIG. 8, the product proposal information generating unit 35b transmits, after the processing in S203, the equipment list display information generated in S203 via the network communication unit 33 to the user terminal 20 (S204).

When the control unit 25 of the user terminal 20 receives via the network communication unit 23 the equipment list display information transmitted from the sales support server 30 in S204, the control unit 25 displays the equipment list screen 80 as shown in FIG. 9 based on the received equipment list display information (S205).

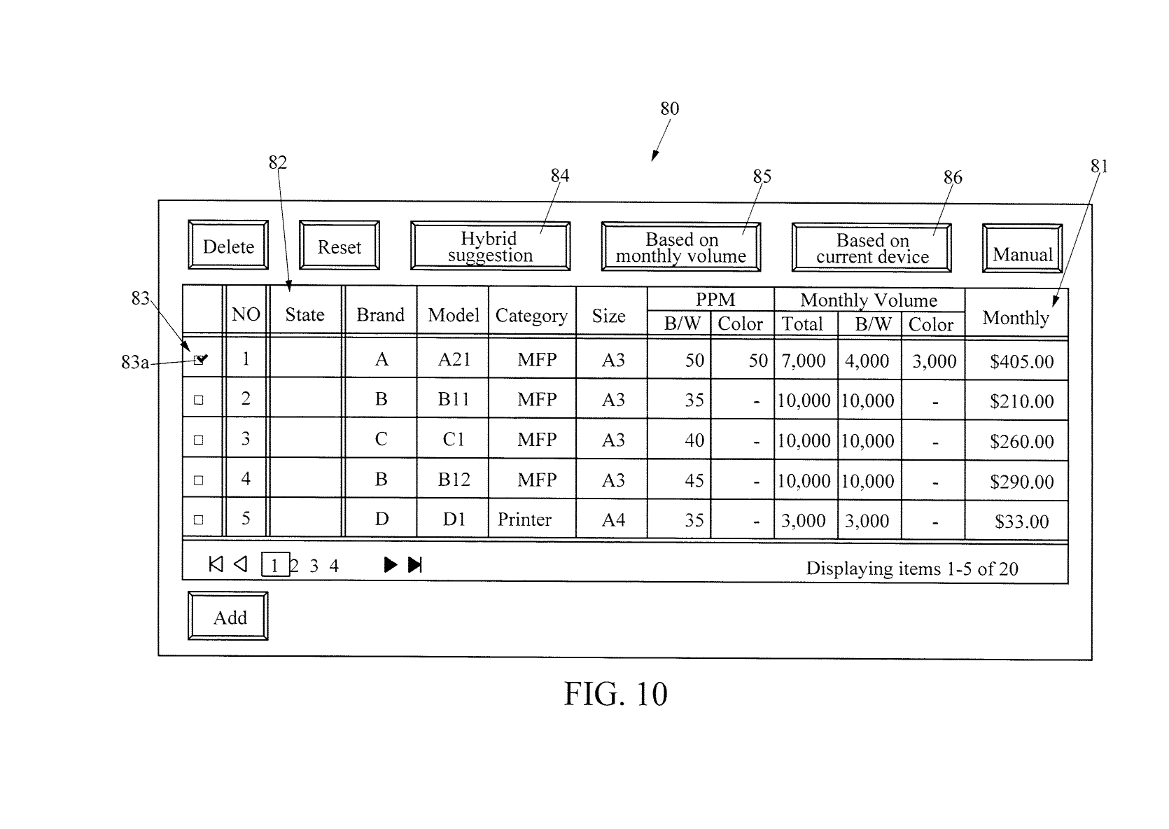

When a piece of used equipment is selected via the operation unit 21 by selecting the check box 83a on the equipment list screen 80, the control unit 25 causes the check box 83a of the selected used equipment to be in a selected state as illustrated FIG. 10 (S206).

Then, when any one of the buttons 84 to 86 on the equipment list screen 80 is pressed via the operation unit 21, the control unit 25 transmits an instruction for generating the product proposal information via the network communication unit 23 to the sales support server 30 (S207).

Then, the control unit 35 of the sales support server 30 receives via the network communication unit 33 the instruction transmitted from the user terminal 20 in S207 (S208). In this case, the selected equipment receiving unit 35c of the control unit 35 receives the used equipment selected in S206. Further, the selected process receiving unit 35d of the control unit 35 receives a process corresponding to the button that has generated the instruction received in S208 among the buttons 84 to 86 on the instruction equipment list screen 80. In other words, a process for generating the product proposal information selected from the plurality of processes for generating the product proposal information is selected.

Then, the product proposal information generating unit 35b of the control unit 35 generates the product proposal information based on the instruction received in S208 (S209).

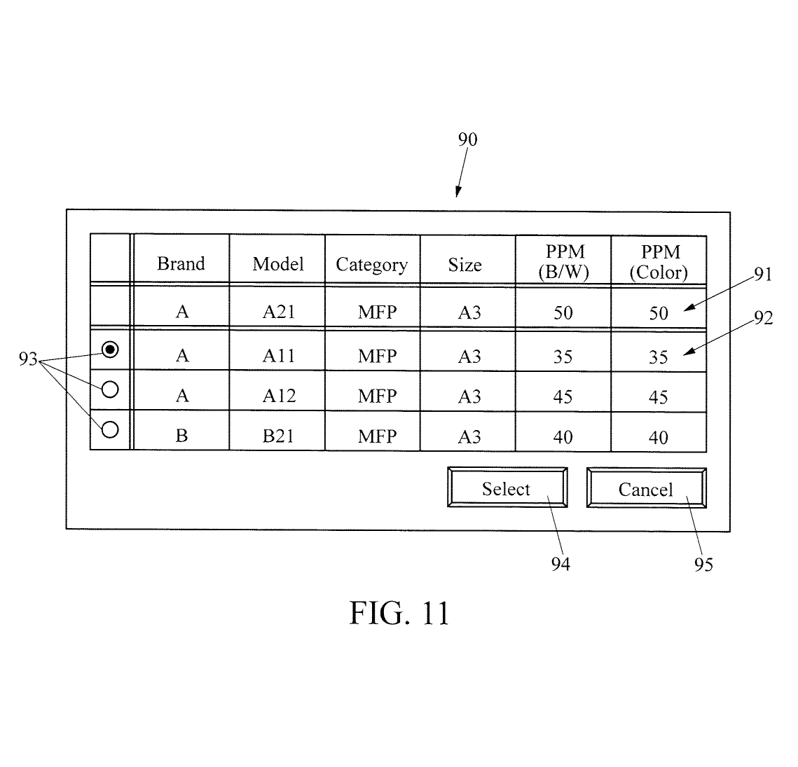

Then, the selected candidate receiving unit 35e of the control unit 35 generates, based on the catalog information 34b on the storage unit 34, information for displaying a candidate list screen 90 that, as shown in FIG. 11, displays a list of product candidates included in the product proposal information that is generated in S209 (hereinafter referred to as “candidate list display information”) (S210).

FIG. 11 illustrates an exemplary candidate list screen 90 displayed on the display unit 22 of the user terminal 20.

As shown in FIG. 11, the candidate list screen 90 includes a used equipment display region 91 for displaying the present used equipment, a candidate display region 92 for displaying a candidate list, radio buttons 93 for selecting a candidate among candidates displayed in the candidate display region 92, a button 94 for providing an instruction for selecting a candidate, and a button 95 for providing an instruction for cancelling selection of a candidate.

The used equipment display region 91 and the candidate display region 92 include, for example, “Brand”, “Model”, “Category”, “Size”, “PPM (B/W)”, and “PPM (Color)”. The item “PPM (B/W)” is the same as the item “B/W” in the item “PPM” in the catalog information 34b. The item “PPM (Color)” is the same as the item “Color” in the item “PPM” in the catalog information 34b.

As shown in FIG. 8, the selected candidate receiving unit 35e transmits, after the processing in S210, the candidate list display information generated in S210 via the network communication unit 33 to the user terminal 20 (S211).

When the control unit 25 of the user terminal 20 receives via the network communication unit 23 the candidate list display information transmitted from the sales support server 30 in S211, the control unit 25 displays on the display unit 22 the candidate list screen 90 as shown in FIG. 11 based on the received candidate list display information (S212).

When a candidate is selected via the operation unit 21 by selecting one of the radio buttons 93 on the candidate list screen 90 and the button 94 on the candidate list screen 90 is pressed on the operation unit 21, the control unit 25 transmits a notification of the candidate selected by the radio button 93 via the network communication unit 23 to the sales support server 30 (S213).

Then, the selected candidate receiving unit 35e of the control unit 35 of the sales support server 30 receives the selected candidate based on the notification transmitted from the user terminal 20 in S213 (S214).

Then, the product proposal information generating unit 35b of the control unit 35 modifies the equipment list display information by modifying the product proposal information for the candidate received in S214 (S215).

Then, the product proposal information generating unit 35b transmits the equipment list display information modified in S215 via the network communication unit 33 to the user terminal 20 (S216).

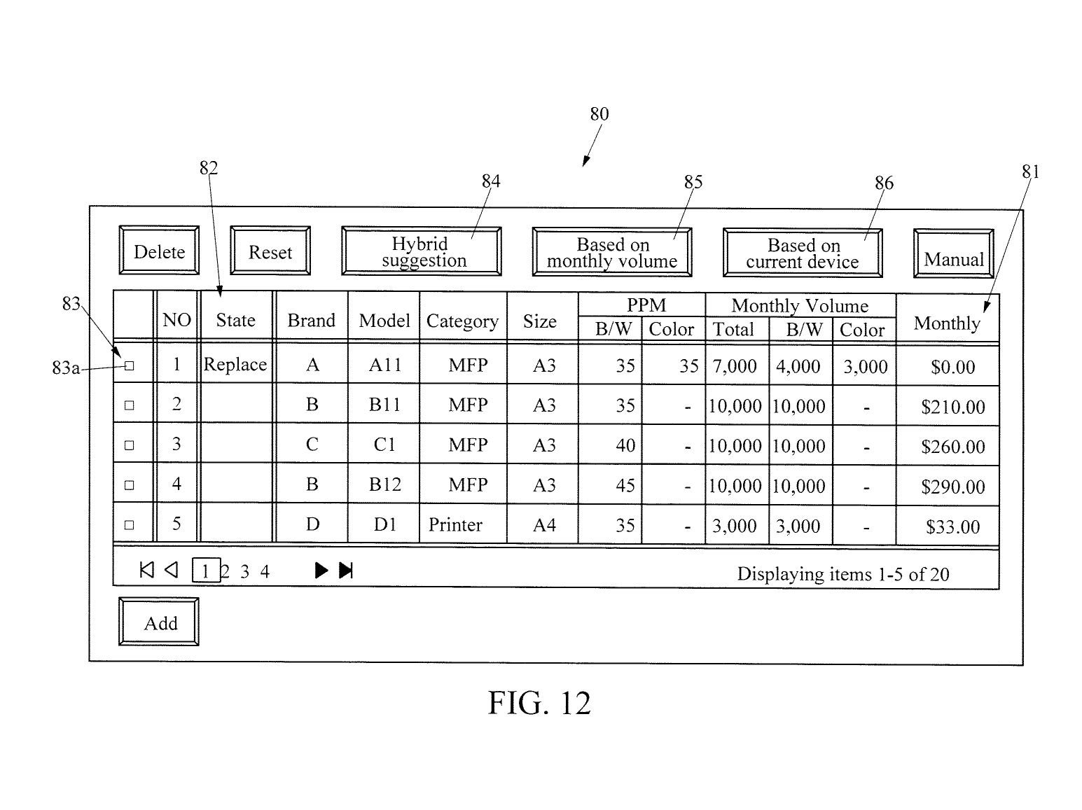

When the control unit 25 of the user terminal 20 receives via the network communication unit 23 the equipment list display information transmitted from the sales support server 30 in S216, the control unit 25 displays the equipment list screen 80 as shown in FIG. 12 based on the received equipment list display information (S217).

The equipment list screen 80 as shown in FIG. 12 indicates a state in which, in the equipment list screen 80 as shown in FIG. 9, regarding the first image forming apparatus, the used equipment is replaced with a proposed product and the value of the item “State” is modified to be “Replace”.

The flow when the product proposal information is generated is described above. The dealer as the user of the user terminal 20 can propose a product suitable for a customer by, for example, presenting to the customer the product proposal information displayed on the display unit 22. The customer can, for example, reduce the maintenance cost of the image forming apparatus by, for example, replacing the present used equipment with the proposed product based on the product proposal information.

Note that, if a plurality of pieces of used equipment is selected in S206, the candidate list screen 90 is displayed on the display unit 22 of the user terminal 20 regarding each of the plurality of pieces of used equipment selected in S206.

Further, in the above, the case in which the button 94 of the candidate list screen 90 is pressed has been described. When the button 95 of the candidate list screen 90 is pressed, the used equipment included in the candidate list screen 90 is not replaced with a proposed product in the equipment list screen 80.

Further, in the above, the case in which product candidates are included in the product proposal information generated in S209 has been described. When no product candidate is included in the product proposal information, instead of displaying a product candidate, information indicating that no product candidate is found, for example, a message “!Not find satisfactory machine” is displayed on the candidate list screen 90.

Next, generation of the product proposal information in S209 is described.

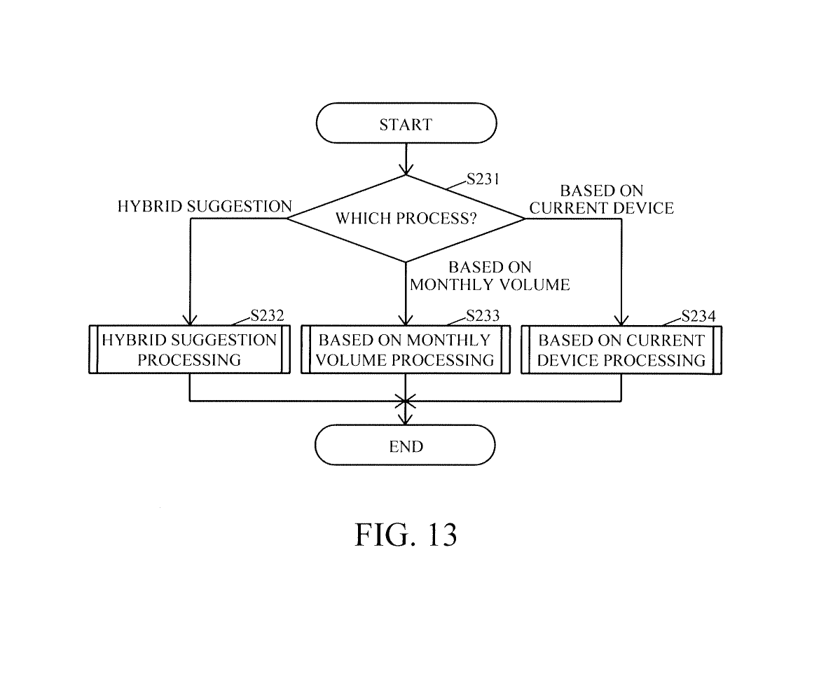

FIG. 13 shows a procedure of operations of the sales support server 30 when the product proposal information is generated.

As shown in FIG. 13, the product proposal information generating unit 35b of the control unit 35 of the sales support server 30 determines which process is received in S208 (S231).

When the process received in S208 is determined to be “Hybrid suggestion” in S231, the product proposal information generating unit 35b executes Hybrid suggestion processing as shown in FIG. 14 (S232) and ends operations as shown in FIG. 13.

FIG. 14 shows a process of the “Hybrid suggestion” processing.

As shown in FIG. 14, the product proposal information generating unit 35b determines whether or not the total value of the value of the item “Copy Ratio” and value of the item “FAX Ratio” of the used equipment received in S208 (hereinafter referred to as “target used equipment”) in the used equipment information 50a exceeds the first threshold 34c for selecting a product kind (S301). Note that the product kind may be an “MFP” or a “Printer,” for example.

When the product proposal information generating unit 35b determines that the total value does not exceed the first threshold 34c for selecting a product kind in S301, the product proposal information generating unit 35b determines whether or not the value of the item “Monthly Scan” of the target used equipment in the used equipment information 50a exceeds the second threshold 34d for selecting a product kind (S302).

When the product proposal information generating unit 35b determines that the total value exceeds the first threshold 34c for selecting a product kind in S301 or when the product proposal information generating unit 35b determines that the value of the item “Monthly Scan” exceeds the second threshold 34d for selecting a product kind in S302, the product proposal information generating unit 35b sets the product kind of the product candidate to be proposed to be “MFP” (S303).

When the product proposal information generating unit 35b determines that the value of the item “Monthly Scan” does not exceed the second threshold 34d for selecting a product kind in S302, the product proposal information generating unit 35b sets the product kind of the product candidate to be proposed to be “Printer” (S304).

After the processing in S303 or S304, the product proposal information generating unit 35b determines whether or not the value of the item “Large Size Ratio” of the target used equipment in the used equipment information 50a exceeds the third threshold 34e for selecting a machine print size (S305). Note that the machine print size may be an A3 machine or an A4 machine, for example.

When the product proposal information generating unit 35b determines that the value of the item “Large Size Ratio” exceeds the third threshold 34e for selecting a machine print size in S305, the product proposal information generating unit 35b sets the machine print size of the product candidate to be proposed to be an A3 machine (S306).

On the other hand, when the product proposal information generating unit 35b determines that the value of the item “Large Size Ratio” does not exceed the third threshold 34e for selecting a machine print size in S305, the product proposal information generating unit 35b sets the machine print size of the product candidate to be proposed to be an A4 machine (S307).

After the processing in S306 or S307, the product proposal information generating unit 35b determines whether or not the target used equipment is a color machine based on the value of the item “Color” in the item “PPM” in the catalog information 34b (S308). Specifically, if the value of the item “Color” is a value other than “−”, the product proposal information generating unit 35b determines that the target used equipment is a color machine, and, if the value of the item “Color” is “−”, the product proposal information generating unit 35b determines that the target used equipment is a monochrome machine.

When the product proposal information generating unit 35b determines that the target used equipment is a color machine in S308, the product proposal information generating unit 35b sets the product candidate to be proposed to be a color machine (S309).

On the other hand, when the product proposal information generating unit 35b determines that the target used equipment is not a color machine in S308, the product proposal information generating unit 35b sets the product candidate to be proposed to be a monochrome machine (S310).

After the processing in S309 or S310, the product proposal information generating unit 35b sets the print speed range of the product candidate to be proposed based on the print speed range table according to the setting in S303 or S304, the setting in S306 or S307, and the setting in S309 or S310 and on the value of the item “Total” in the item “Monthly Volume” of the target used equipment in the used equipment information 50a (S311).

For example, if the product kind of the product candidate to be proposed is set to be “MFP” in S303, the product candidate to be proposed is set to be an A3 machine in S306, and the product candidate to be proposed is set to be a color machine in S309, the product proposal information generating unit 35b selects the first print speed range table 34f for an A3 color MFP shown in FIG. 5 as a print speed range table based on these settings. If the value of the item “Total” in the item “Monthly Volume” of the target used equipment in the used equipment information 50a is “7,000”, “7,000” as the value of the item “Total” in the item “Monthly Volume” of the target used equipment in the used equipment information 50a is included in “6,000-7,999” as the value of the item “Recommended Monthly Print Paper Count Range” in the first print speed range table 34f for an A3 color MFP; thus, the product proposal information generating unit 35b sets “31-45” as the value of the item “PPM Range” corresponding to “6, 000-7, 999” as the value of the item “Recommended Monthly Print Paper Count Range” in the first print speed range table 34f for an A3 color MFP as the print speed range of the product candidate to be proposed.

The product proposal information generating unit 35b extracts, after the processing in S311, products that satisfy the condition set in S303 or S304 (product kind), the condition set in S306 or S307 (machine print size), the condition set in S309 or S310 (color or monochrome), and the condition set in S311 (print speed range) from the catalog information 34b. The product proposal information generating unit 35b also generates the product proposal information that includes the extracted products as product candidates (S312). Note that, if the product candidate to be proposed is set to be a color machine in S309, the product proposal information generating unit 35b determines that a product whose value of the item “Color” in the item “PPM” in the catalog information 34b is included in the print speed range that is set in S311 is a product that satisfies the condition set in S311 (print speed range). Similarly, if the product candidate to be proposed is set to be a monochrome machine in S310, the product proposal information generating unit 35b determines that a product whose value of the item “B/W” in the item “PPM” in the catalog information 34b is included in the print speed range that is set in S311 is a product that satisfies the condition set in S311 (print speed range).

After the processing in S312, the product proposal information generating unit 35b terminates the operation as shown in FIG. 14.

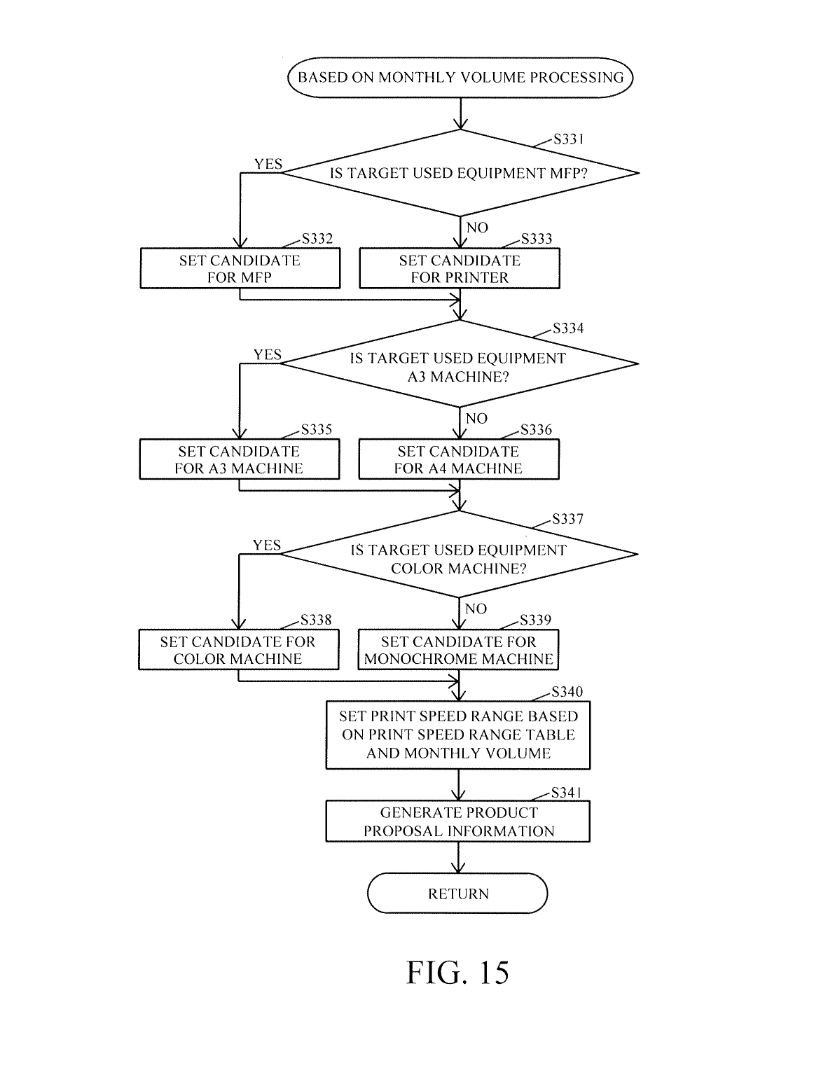

As shown in FIG. 13, when the process received in S208 is determined “Based on monthly volume” in S231, the product proposal information generating unit 35b executes “Based on monthly volume” processing in FIG. 15 (S233) and terminates the operation in FIG. 13.

FIG. 15 illustrates a process of the “Based on monthly volume” processing.

As shown in FIG. 15, the product proposal information generating unit 35b determines whether the target used equipment is an MFP or not based on the value of the item “Category” in the catalog information 34b (S331).

When the product proposal information generating unit 35b determines that the target used equipment is an MFP in S331, the product proposal information generating unit 35b sets the product kind of the product candidate to be proposed to be “MFP” (S332).

On the other hand, when the product proposal information generating unit 35b determines that the target used equipment is not an MFP in S331, the product proposal information generating unit 35b sets the product kind of the product candidate to be proposed to be “Printer” (S333).

After the processing in S332 or S333, the product proposal information generating unit 35b determines whether or not the target used equipment is an A3 machine based on the value of the item “Size” in the catalog information 34b (S334).

When the product proposal information generating unit 35b determines that the target used equipment is an A3 machine in S334, the product proposal information generating unit 35b sets the machine print size of the product candidate to be proposed to be an A3 machine (S335).

On the other hand, when the product proposal information generating unit 35b determines that the target used equipment is not an A3 machine in S334, the product proposal information generating unit 35b sets the machine print size of the product candidate to be proposed to be an A4 machine (S336).

After the processing in S335 or S336, the product proposal information generating unit 35b executes processing in S337 to S339 similarly to the processing in S308 to S310 in the process depicted in FIG. 14.

After the processing in S338 or S339, the product proposal information generating unit 35b sets, similarly to the processing in S311 in the process depicted in FIG. 14, the print speed range of the product candidate to be proposed based on the print speed range table based on the setting in S332 or S333, the setting in S335 or S336, and the setting in S338 or S339 and on the value of the item “Total” in the item “Monthly Volume” of the target used equipment in the used equipment information 50a (S340).

Then, the product proposal information generating unit 35b extracts, similarly to the processing in S312 in the process depicted in FIG. 14, products that satisfy the condition set in S332 or S333 (product kind), the condition set in S335 or S336 (machine print size), the condition set in S338 or S339 (color or monochrome), and the condition set in S340 (print speed range) from the catalog information 34b. The product proposal information generating unit 35b also generates the product proposal information that includes the extracted products as product candidates (S341), and terminates the operation as shown in FIG. 15.

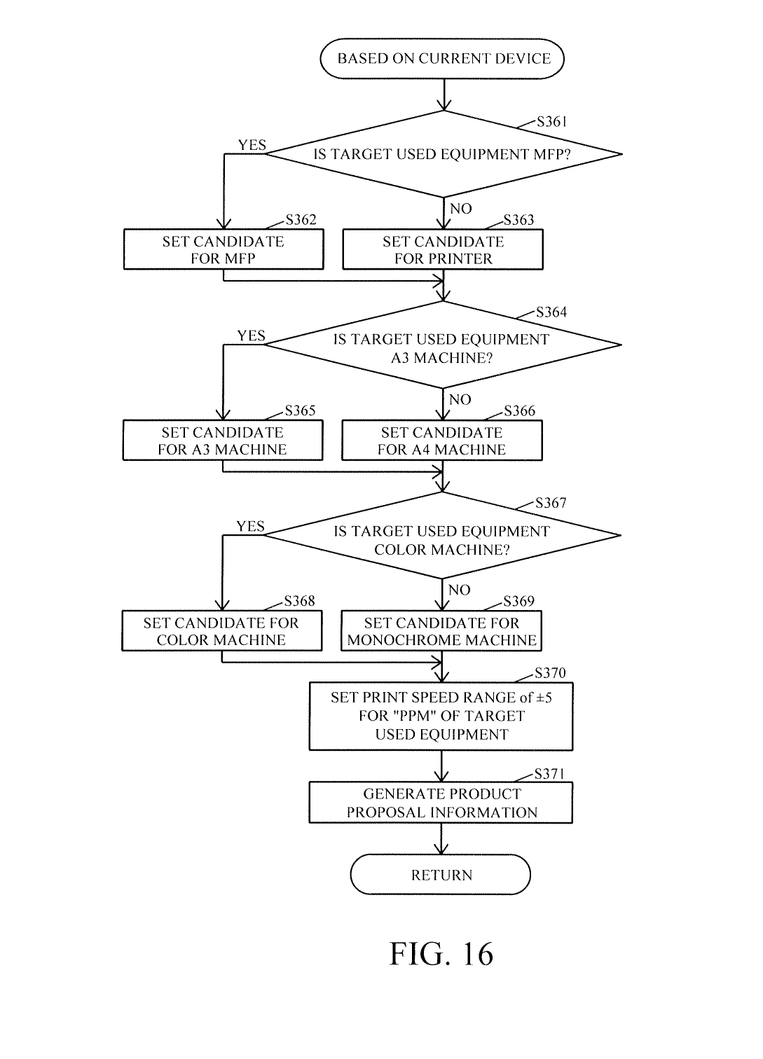

As shown in FIG. 13, when the process received in S208 is determined “Based on current device” in S231, the product proposal information generating unit 35b executes “Based on current device processing” as shown in FIG. 16 (S234) and terminates the operation as shown in FIG. 13.

FIG. 16 illustrates a process of the “Based on current device” processing.

As shown in FIG. 16, the product proposal information generating unit 35b executes processing in S361 to S369 similarly to the processing in S331 to S339 in the process depicted in FIG. 15.

After the processing in S368 or S369 (color or monochrome), the product proposal information generating unit 35b sets a range of from a value that is the value of the item “PPM” of the target used equipment in the catalog information 34b plus or minus 5 as the print speed range (S370). Note that, if the product candidate to be proposed is set to be a color machine in S368, the product proposal information generating unit 35b sets a range of from a value that is the value of the item “Color” in the item “PPM” in the catalog information 34b plus or minus 5 as the print speed range. If the product candidate to be proposed is set to be a monochrome machine in S369, the product proposal information generating unit 35b sets a range of from a value that is the value of the item “B/W” in the item “PPM” in the catalog information 34b plus or minus 5 as the print speed range.

Then, the product proposal information generating unit 35b extracts, similarly to the processing in S312 in the process depicted in FIG. 14, products that satisfy the condition set in S362 or S363 (product kind), the condition set in S365 or S366 (machine print size), the condition set in S368 or S369 (color or monochrome), and the condition set in S370 (print speed range) from the catalog information 34b. The product proposal information generating unit 35b also generates the product proposal information that includes the extracted products as product candidates (S371), and terminates the operation as shown in FIG. 16.

As described above, the sales support system 10 generates the product proposal information 34n using the process based on the determination by the dealer (S231 to S234) by enabling the dealer to select the process for generating the product proposal information 34n based on the used equipment information 50a (S207), and thus, the product proposal information 34n can be generated using the appropriate process. In other words, the sales support system 10 can make the proposal of a product more suitable.

Specifically, the sales support system 10 can enable the dealer to select any one of “Based on monthly volume”, “Based on current device”, or “Hybrid suggestion” processing. The “Based on monthly volume” process may be used for extracting products based on the specification value of the used equipment in relation to the item “Category” indicating the kind of the image forming apparatus based on the kind of the job executable by the image forming apparatus (S331 to S333 and S341). The “Based on current device” may be used for extracting products based on the specification value of the used equipment in relation to the item “Category” (S361 to S363 and S371). The “Hybrid suggestion” may be used for extracting products based on the actual usage of the used equipment in relation to the item “Category” (S301 to S304 and S312). Therefore, products extracted based on any one of the specification value of the used equipment and the actual usage of the used equipment on which the dealer places importance can be proposed, and, as a result, it is possible to make the proposal of a product more suitable.

Further, the sales support system 10 can enable the dealer to select any one of “Based on monthly volume” as the process for extracting products based on the specification value of the used equipment in relation to the item “Size” indicating the maximum paper size printable by the image forming apparatus (S334 to S336 and S341), “Based on current device” as the process for extracting products based on the specification value of the used equipment in relation to the item “Size” (S364 to S366 and S371), or “Hybrid suggestion” as the process for extracting products based on the actual usage of the used equipment in relation to the item “Size” (S305 to S307 and S312). Therefore, products extracted based on any one of the specification value of the used equipment and the actual usage of the used equipment on which the dealer places importance can be proposed, and, as a result, it is possible to make the proposal of a product more suitable.

Further, the sales support system 10 can enable the dealer to select anyone of “Based on current device” as the process for extracting products based on the specification value of the used equipment in relation to the item “PPM” indicating the print speed of the image forming apparatus (S370 and S371), “Hybrid suggestion” as the process for extracting products based on the actual usage of the used equipment in relation to the item “PPM” (S311 and S312), and “Based on monthly volume” as the process for extracting products based on the actual usage of the used equipment in relation to the item “PPM” (S340 and S341). Therefore, products extracted based on any one of the specification value of the used equipment and the actual usage of the used equipment on which the dealer places importance can be proposed, and, as a result, it is possible to make the proposal of a product more suitable.

The sales support system 10 can automatically generate the product proposal information 34n by simple operation in which, after the used equipment information 50a is input from the user terminal 20 to the sales support server 30 (S201), instruction for generating the product proposal information 34n is input from the user terminal 20 to the sales support server 30 (S207). Therefore, even when the dealer does not have much knowledge about the products, by using the sales support system 10, the dealer can easily propose to a customer a product that is suitable for the customer.

The sales support system 10 can propose a product (S216 and S217) in relation to the used equipment selected by the dealer (S206). Therefore, a product can be proposed in relation to suitable used equipment. In other words, the sales support system 10 can make the proposal of a product more suitable.

Further, even when a plurality of pieces of used equipment are selected by the dealer (S206), the sales support system 10 can propose a product suitable for the customer regarding each of the plurality of pieces of used equipment selected by the dealer (S216 and S217) only by execution once of an instruction for generating the product proposal information by the dealer (S207). In other words, the sales support system 10 can enhance the convenience for the dealer who executes an instruction for generating the product proposal information.

The sales support system 10 can propose a product selected by the dealer among the product candidates (S210 to S217). Therefore, a suitable product can be proposed. In other words, the sales support system 10 can make the proposal of a product more suitable.

In the embodiment of the present disclosure, the used equipment and the products are image forming apparatus, but the used equipment and the products may be equipment other than image forming apparatus.

It should be understood that various changes and modifications to the presently embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A sales support system, comprising:
a used equipment information receiving unit configured to receive used equipment information regarding a used equipment of a customer;
a product proposal information generating unit configured to generate product proposal information that is used to propose a product to the customer; and
a selected process receiving unit configured to receive a process for generating the product proposal information selected from a plurality of processes for generating the product proposal information by the product proposal information generating unit,
wherein the product proposal information generating unit is further configured to generate the product proposal information using the process received by the selected process receiving unit based on the used equipment information received by the used equipment information receiving unit.

2. The sales support system according to claim 1, wherein the plurality of processes for generating the product proposal information comprises:
a first process for extracting the product based on a specification value of the used equipment in relation to a specific item for extracting the product generated by the product proposal information generating unit; and
a second process for extracting the product based on actual usage of the used equipment based on the used equipment information in relation to the item.

3. The sales support system according to claim 2, wherein:
the used equipment and the product comprise an image forming apparatus; and
the specific item includes an item indicating a kind of the image forming apparatus based on a kind of a job executable by the image forming apparatus.

4. The sales support system according to claim 2, wherein:
the used equipment and the product comprise an image forming apparatus; and
the specific item includes an item indicating a maximum paper size printable by the image forming apparatus.

5. The sales support system according to claim 2, wherein:
the used equipment and the product comprise an image forming apparatus; and
the specific item includes an item indicating a print speed of the image forming apparatus.

6. The sales support system according to claim 1, further comprising a selected equipment receiving unit configured to receive a used equipment selected from the used equipment included in the used equipment information,
wherein the product proposal information generating unit is further configured to generate the product proposal information based on the used equipment received by the selected equipment receiving unit.

7. The sales support system according to claim 1, further comprising a selected candidate receiving unit configured to receive a candidate selected from candidates of the product that are included in the product proposal information,
wherein the product proposal information generating unit is further configured to modify the product proposal information for the candidate received by the selected candidate receiving unit.

8. The sales support system according to claim 1, further comprising:
a used equipment information collecting device configured to collect the used equipment information from the used equipment and output the collected used equipment information; and
a user terminal configured to acquire and transmit the collected used equipment information that is output from the used equipment information collecting device,
wherein the used equipment information receiving unit is further configured to receive the used equipment information transmitted from the user terminal.

9. A sales support method, comprising:
receiving, via a used equipment information receiving unit, used equipment information about a used equipment of a customer;
generating, via a product proposal information generating unit, product proposal information that is used to propose a product to the customer;
receiving, via a selected process receiving unit, a process for generating the product proposal information selected from a plurality of processes for generating the product proposal information by the product proposal information generating unit; and
generating, via the product proposal information generating unit, the product proposal information using the process received by the selected process receiving unit based on the used equipment information received by the used equipment information receiving unit.

10. The sales support method according to claim 9, wherein the plurality of processes for generating the product proposal information comprises:
a first process for extracting the product based on a specification value of the used equipment in relation to a specific item for extracting the product generated by the product proposal information generating unit; and
a second process for extracting the product based on actual usage of the used equipment based on the used equipment information in relation to the item.

11. The sales support method according to claim 10, wherein:
the used equipment and the product comprise image forming apparatus; and
the specific item includes an item indicating a kind of the image forming apparatus based on a kind of a job executable by the image forming apparatus, and item indicating a maximum paper size printable by the image forming apparatus, and an item indicating a print speed of the image forming apparatus.

12. The sales support method according to claim 9, further comprising:
receiving, via a selected equipment receiving unit, a used equipment selected from the used equipment included in the used equipment information,
wherein the product proposal information generating unit is further configured to generate the product proposal information based on the used equipment received by the selected equipment receiving unit.

13. The sales support method according to claim 9, further comprising:
receiving, via a selected candidate receiving unit, a candidate selected from candidates of the product that are included in the product proposal information,
wherein the product proposal information generating unit is further configured to modify the product proposal information for the candidate received by the selected candidate receiving unit.

14. The sales support method according to claim 9, further comprising:
collecting, via a used equipment information collecting device, the used equipment information from the used equipment and output the collected used equipment information;
acquiring, via a user terminal, the collected used equipment information that is output from the used equipment information collecting device; and
transmitting, via the user terminal, the collected used equipment information that is output from the used equipment information collecting device,
wherein the used equipment information receiving unit is further configured to receive the used equipment information transmitted from the user terminal.

15. A non-transitory computer-readable recording medium that stores a sales support program executable by a computer, the sales support program comprising:
a first program code for causing the computer to receive used equipment information regarding a used equipment of a customer;
a second program code for causing the computer to generate product proposal information that is used to propose a product to the customer; and
a third program code for causing the computer to receive a process for generating the product proposal information selected from a plurality of processes for generating the product proposal information by the second program code,
wherein the second program code further causes the computer to generate the product proposal information using the process received by the third program code based on the used equipment information received by the first program code.

16. The non-transitory computer-readable recording medium according to claim 15, wherein the plurality of processes for generating the product proposal information comprises:
a first process for extracting the product based on a specification value of the used equipment in relation to a specific item for extracting the product generated by the second program code; and
a second process for extracting the product based on actual usage of the used equipment based on the used equipment information in relation to the item.

17. The non-transitory computer-readable recording medium according to claim 16, wherein:
the used equipment and the product comprise an image forming apparatus; and
the specific item includes an item indicating a kind of the image forming apparatus based on a kind of a job executable by the image forming apparatus, and item indicating a maximum paper size printable by the image forming apparatus, and an item indicating a print speed of the image forming apparatus.

18. The non-transitory computer-readable recording medium according to claim 15, wherein the sales support program further comprises:
a fourth program code for causing the computer to receive a used equipment selected from the used equipment included in the used equipment information,
wherein the second program code further causes the computer to generate the product proposal information based on the used equipment received by the fourth program code.

19. The non-transitory computer-readable recording medium according to claim 15, wherein the sales support program further comprises:
a fifth program code for causing the computer to receive a candidate selected from candidates of the product that are included in the product proposal information,
wherein the second program code further causes the computer to modify the product proposal information for the candidate received by the fifth program code.

20. The non-transitory computer-readable recording medium according to claim 15, wherein the sales support program further comprises:
a sixth program code for causing the computer to collect the used equipment information from the used equipment and output the collected used equipment information;
a seventh program code for causing the computer to acquire the collected used equipment information that is output from the used equipment information collecting device; and
an eighth program code for causing the computer to transmit the collected used equipment information that is output from the used equipment information collecting device,
wherein the second program code further causes the computer to receive the used equipment information transmitted from the user terminal.
